(19) United States
(12) Patent Application Publication
(10) Pub. No.: US 2016/0229588 A1
(43) Pub. Date: Aug. 11, 2016

(54) SUPPORT CLIPS FOR INDUSTRIAL BINS

(71) Applicants: Christopher Clark, Parma, OH (US); Gerald A. Sciarini, Seville, OH (US); Travis D. Shamp, Akron, OH (US)

(72) Inventors: Christopher Clark, Parma, OH (US); Gerald A. Sciarini, Seville, OH (US); Travis D. Shamp, Akron, OH (US)

(21) Appl. No.: 14/616,604

(22) Filed: Feb. 6, 2015

(51) Int. Cl. B65D 25/22; F16M 13/02

(52) U.S. Cl. CPC B65D 25/22; F16M 13/02

(57) ABSTRACT

The support clip for industrial bins includes at least one support on the clip and can be used to increase the hanging load of an industrial bin when hung. The supports may be in the form of ledges or cleats. The multi-support clip provides additional hanging strength for existing bins or allows flexibility to use bins manufactured of more economical or recycled polymers that tend to be softer or less rigid. The additional supports on the clip may also allow the bin to be hung in a sloped forward configuration. The use of multi-support clips allow for improved bin strength when hung and flexibility for placement and use of bins already in service. The support clip is manufactured by a process of metal extrusion, metal stamping, or metal die casting or polymer extrusion, thermoforming, injection molding, blow molding, and rotocasting.

### FIELD OF THE INVENTION

The present invention relates to support systems for industrial bins that are commonly used in storage and transport bin systems for use in industrial assembly. The support clip for industrial bins includes at least one supports on the clip and can be used to increase the hanging load of an industrial bin when hung. The supports may be in the form of ledges or cleats. The support clip provides additional hanging strength for existing bins or allows flexibility to use bins manufactured of more economical or recycled polymers that tend to be softer or less rigid. The additional supports on the clip may also allow the bin to be hung in a sloped forward configuration. The use of multi-support clips allow for improved bin strength when hung and flexibility for placement and use of bins already in service.

### BACKGROUND

Bin systems are often used in industrial sites to aid in storing and sorting a number of small parts. Typically, the bins are open topped and hung horizontally from a single clip formed on the back wall of the bin when the bin is formed. Generally, the bins either hang from a single clip or do not include a support and are placed on a shelf.

### SUMMARY

In accordance with embodiments of the present invention, a multi-support, such as a multi-cleat or multi-ledge, support clips for industrial bins are disclosed having a rear wall, a rail formed at the upper edge of the rear wall having a support formed thereon and a lower step at the lower edge of the rear wall, having a clip or ledge. One or more clips or ledges may be included in the central portion of the clip. The clip may include an inverted L-arm sized to fit over the rear wall of an industrial bin or an angled arm that fits into notches formed in the sidewalls of the bin. The support clip may be formed of metal by extrusion, stamping, or may be die cast or formed by polymer by extrusion, thermoforming, injection molding, blow molding, and rotocasting. Also disclosed is a hanging bin having a base, a front wall, two opposing side walls and a substantially vertical rear wall having an upper rim, a midsection and a lower rim with a first support proximate the upper rim of the rear wall and one or more ledges formed in the rear wall beneath the first support.

### BRIEF DESCRIPTION OF THE DRAWINGS

A more complete appreciation of the invention and the many embodiments thereof will be readily obtained as the same becomes better understood by reference to the following detailed description when considered in connection with the accompanying drawings, wherein:

FIG. 1A illustrates an isometric view of a multi-cleat support clip for industrial bins with four cleats in accordance with the present invention;

FIG. 1B illustrates a rear plan view of a multi-cleat support clip for industrial bins with four cleats in accordance with the present invention

FIG. 1C a side plan view of a multi-cleat support clip for industrial bins with four cleats in accordance with the present invention;

FIG. 1D a side plan view of a multi-cleat support clip for industrial bins with four cleats in accordance with the present invention installed on a standard industrial bin;

FIG. 2A illustrates an isometric view of a multi-cleat support clip for industrial bins with three cleats in accordance with the present invention;

FIG. 2B illustrates a rear plan view of a multi-cleat support clip for industrial bins with three cleats in accordance with the present invention

FIG. 2C a side plan view of a multi-cleat support clip for industrial bins with three cleats in accordance with the present invention;

FIG. 2D a side plan view of a multi-cleat support clip for industrial bins with three cleats in accordance with the present invention installed on a standard industrial bin;

FIG. 2E illustrates an isometric view of a multi-ledge support clip for industrial bins with two ledges in accordance with the present invention;

FIG. 2F illustrates a side plan view of a multi-ledge support clip for industrial bins with 2 ledges in accordance with the present invention and mounted on a louvered panel;

FIG. 2G illustrates an isometric view of a multi-cleat support clip for standard shelf bin in accordance with the present invention;

FIG. 3A illustrates an isometric view of a multi-support clip for industrial bins with two cleats in accordance with the present invention;

FIG. 3B illustrates a rear plan view of a multi-cleat support clip for industrial bins with two cleats in accordance with the present invention

FIG. 3C a side plan view of a multi-cleat support clip for industrial bins with two cleats in accordance with the present invention;

FIG. 3D a side plan view of a multi-cleat support clip for industrial bins with two cleats in accordance with the present invention installed on a standard industrial bin;

FIG. 4A illustrates an isometric view of a single-cleat support shelf for industrial bins in accordance with the present invention; and

FIG. 4B illustrates a side plan view of a single-cleat support shelf for industrial bins in accordance with the present invention.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

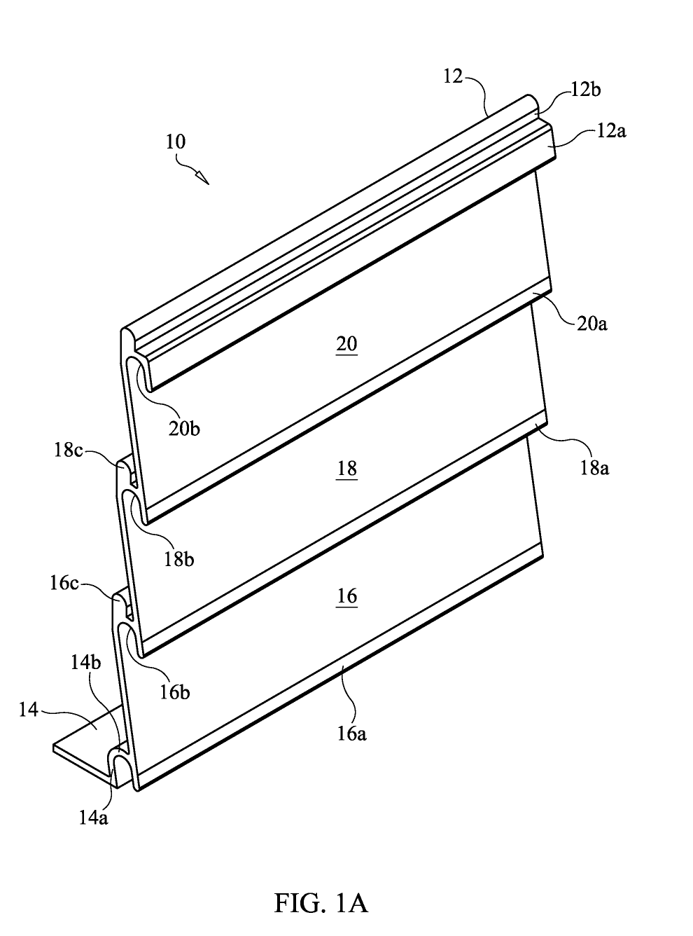

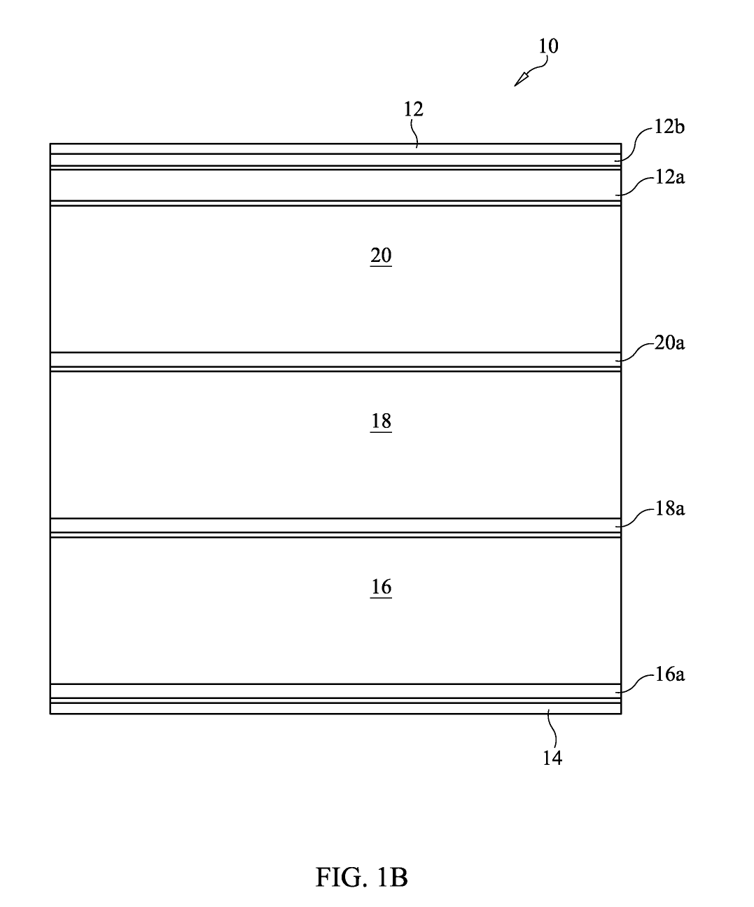

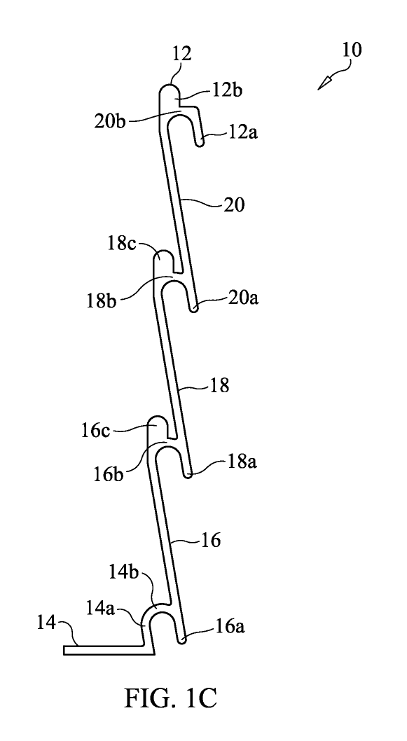

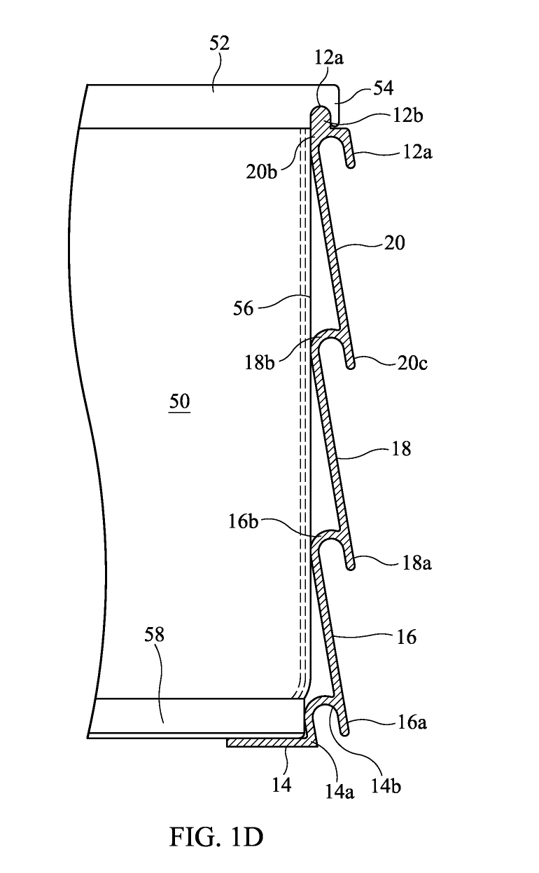

A multi-cleat support clip 10 for industrial bins in accordance with the present invention, is shown in FIG. 1A. Clip 10 includes a top rail 12 that fits into a cleat on a standard commercial bin and lower step 14 that supports the rear lower edge of the bin. Top rail 12 includes a cleat 12a that runs substantially the width of clip 10. The lower step also includes a cleat 14a that runs substantially the width of the clip. Top rail 12 includes upright 12b and cleat 12a. Beneath top rail 12 is a wall 20 with a lower cleat 20a and an upper surface 20b that is curved to receive a mount, such as a louver on a louvered wall. Beneath wall 20 is wall 18 includes lower cleat 18a, an upper surface 18b that is curved to receive a mount, such as a louver on a louvered wall, and a rail 18c. Beneath wall 18 is wall 16 includes lower cleat 16a, an upper surface 16b that is curved to receive a mount, such as a louver on a louvered wall, and a rail 16c. Beneath wall 16 is lower step 14 includes an upright wall 14a and a curved upper surface 14b that is curved to receive a mount, such as a louver on a louvered wall. In use, at least one rail 12, 18c, 16c fit into a cleat on a bin while lower step 14 supports base of the bin. The clip 10 is placed on a louvered panel with at least one of cleats 12a, 20a, 18a, 16a on a louver of a louvered panel or other wall mount system. Cleats 12a, 20a, 18a, 16a carry the weight of a bin and distribute the load across the back wall of the bin so that a higher load may be placed in the bin when hung on as a part of a mounting system.

The rear of a multi-cleat support clip for industrial bins of the present invention, is shown in FIG. 1B. Clip 10 includes a top rail 12 that fits into a cleat on a standard commercial bin and lower step 14 that supports the rear lower edge of the bin. Top rail 12 includes upright 12b and cleat 12a. Intermediate wall 20 includes a lower cleat 20a. A second intermediate wall 18 includes lower cleat 18a. A third intermediate wall 16 includes lower cleat 16a, Cleats 12a, 20a, 18a, 16a attach to louvers or other mounts on a rack system.

The side view of a multi-cleat support clip for industrial bins of the present invention is shown in FIG. 1C. Clip 10 includes a top rail 12 that fits into a cleat on a standard commercial bin and lower step 14 that supports the rear lower edge of the bin. Top rail 12 includes a cleat 12a that runs substantially the width of clip 10. The lower step also includes a cleat 14a that runs substantially the width of the clip. Top rail 12 includes upright 12b and cleat 12a. Beneath top rail 12 is a wall 20 with a lower cleat 20a and an upper surface 20b that is curved to receive a mount, such as a louver on a louvered wall. Beneath wall 20 is wall 18 includes lower cleat 18a, an upper surface 18b that is curved to receive a mount, such as a louver on a louvered wall, and a rail 18c. Beneath wall 18 is wall 16 includes lower cleat 16a, an upper surface 16b that is curved to receive a mount, such as a louver on a louvered wall, and a rail 16c. Beneath wall 16 is lower step 14 includes an upright wall 14a and a curved upper surface 14b that is curved to receive a mount, such as a louver on a louvered wall. In use, at least one rail 12, 18c, 16c fit into a cleat on a bin while lower step 14 supports base of the bin.

The side view of a multi-cleat support clip of the present invention on an industrial bin is shown in FIG. 1D. Clip 10 includes a top rail 12 that fits into a cleat on a standard commercial bin and lower step 14 that supports the rear lower edge of the bin. Top rail 12 includes a cleat 12a that runs substantially the width of clip 10. The lower step also includes a cleat 14a that runs substantially the width of the clip. Top rail 12 includes upright 12b and cleat 12a. Beneath top rail 12 is a wall 20 with a lower cleat 20a and an upper surface 20b that is curved to receive a mount, such as a louver on a louvered wall. Beneath wall 20 is wall 18 includes lower cleat 18a, and an upper surface 18b that is curved to receive a mount, such as a louver on a louvered wall. Beneath wall 18 is wall 16 includes lower cleat 16a, and an upper surface 16b that is curved to receive a mount, such as a louver on a louvered wall. Beneath wall 16 is lower step 14 includes an upright wall 14a and a curved upper surface 14b that is curved to receive a mount, such as a louver on a louvered wall. In use, at least one rail 12, 18c, 16c fit into a cleat on a bin while lower step 14 supports base of the bin. As shown, 12 top rail of clip 10 fits into cleat 54 at top rail 52 of bin 50. Lower step 14 supports base 58 of bin 50 and to distribute the load across the back wall of the bin so that a higher load may be placed in the bin when hung on mounting system.

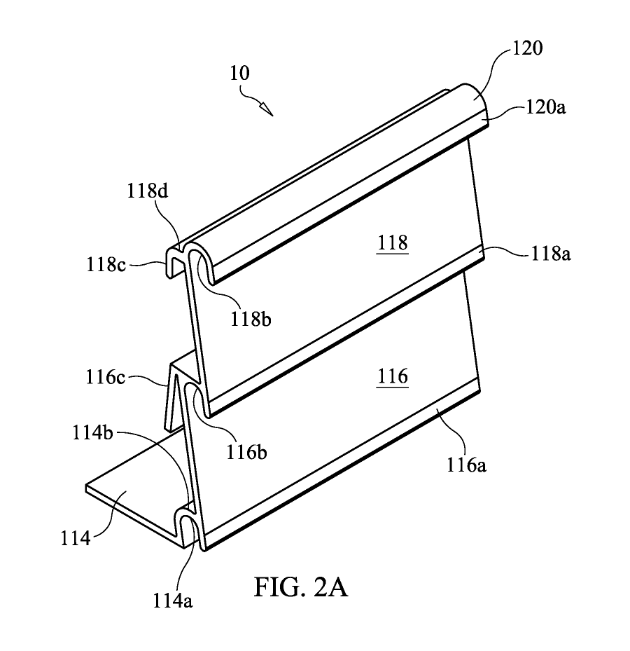

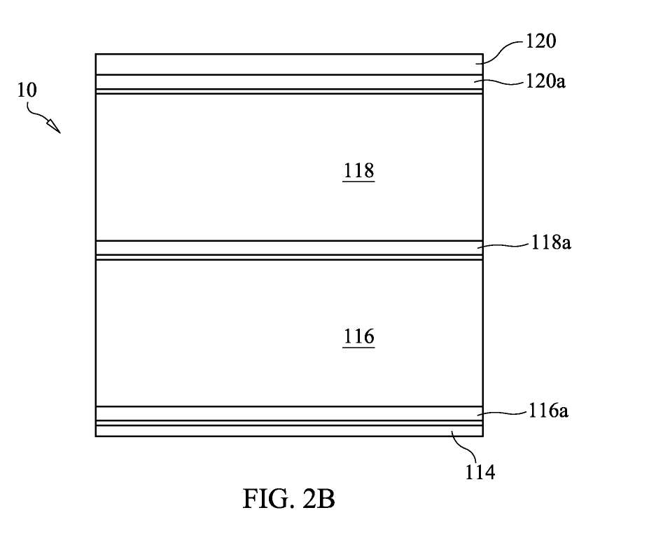

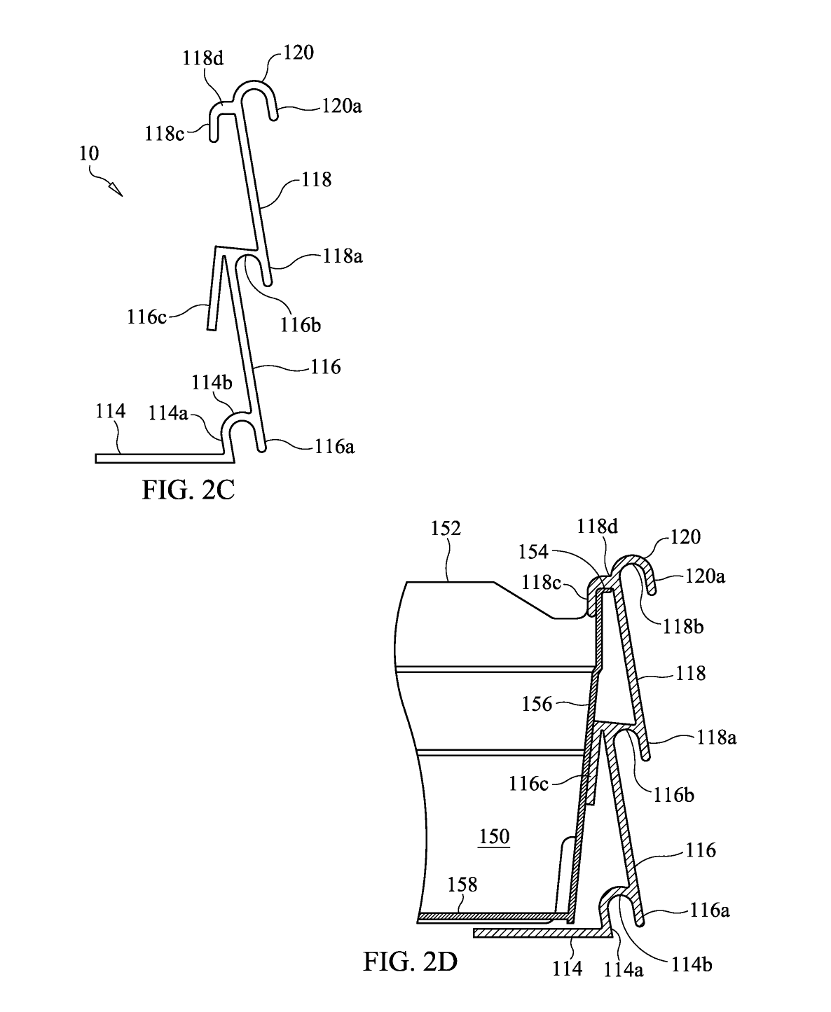

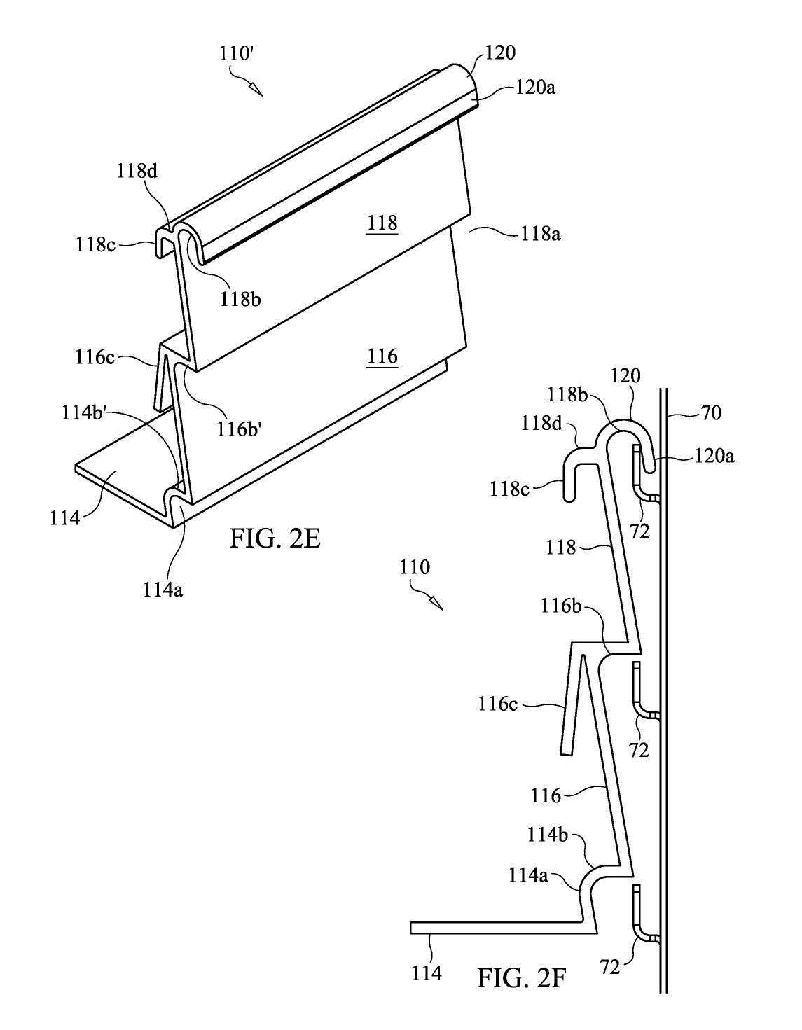

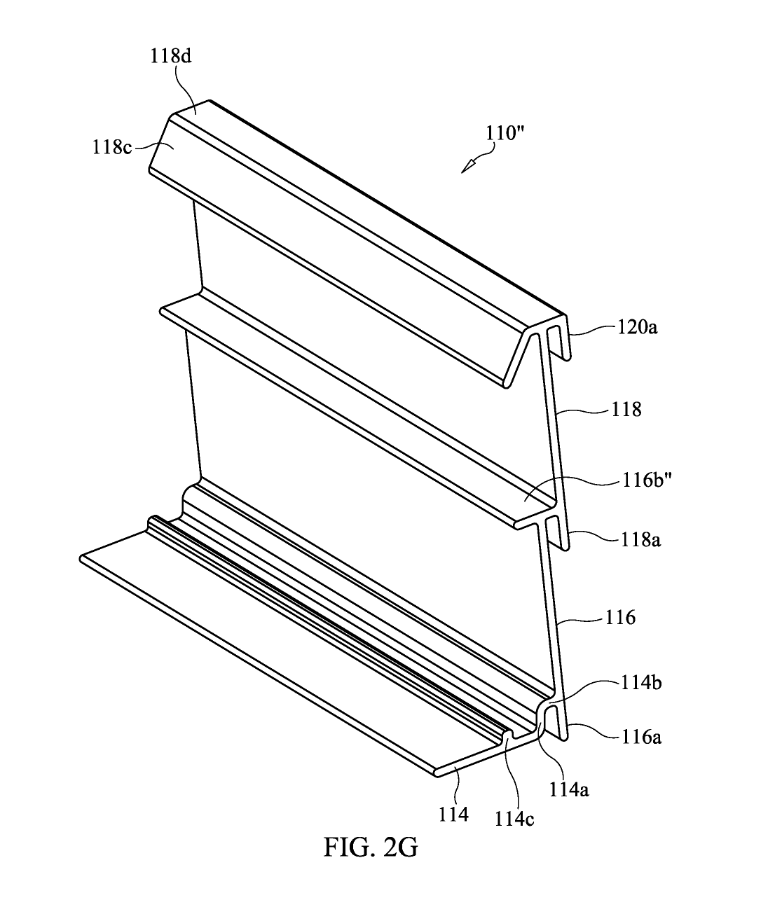

An alternate embodiment of the multi-cleat support clip for industrial bins of the present invention, having three cleats and for use with a standard bin without a top rail cleat is shown in FIG. 2A. Clip 110 includes an internal cleat 118c formed on extension 118d that fits over the rear of a standard commercial bin and lower step 114 that supports the rear lower edge of the bin. Top rail 112 includes a cleat 112a that runs substantially the width of clip 110. The lower step also includes a cleat 114a with curved upper surface 114b that runs substantially the width of the clip. Beneath top rail 112 is a wall 118 with a lower cleat 118a and an upper surface 118b that is curved to receive a mount, such as a louver on a louvered wall. Extension 118d supports internal cleat 118c. Beneath wall 118 is wall 116 includes lower cleat 116a, an upper surface 116b that is curved to receive a mount, such as a louver on a louvered wall, and an internal support 116c. Beneath wall 116 is lower step 114 including upright wall 114a and a curved upper surface 114b that is curved to receive a mount. In use, the upper rim of an industrial bin fits under internal cleat 118c so that the rear of the bin rests against internal support 116c and the base of the bin rests on lower step 114. External cleats 120a, 118a, 116a carry the weight of the bin and distribute the load across the back wall of the bin so that a higher load may be placed in the bin when hung on as a part of a mounting system.

The rear of a multi-cleat support clip for industrial bins of the present invention, is shown in FIG. 2B. Clip 110 includes top rail 112 and cleat 112a that runs substantially the width of clip 110. Beneath top rail 112 is a wall 118 with a lower cleat 118a. Beneath wall 118 is wall 116 includes lower cleat 116a, and lower step 114.

The side view of a multi-cleat support clip for industrial bins of the present invention is shown in FIG. 2C. Clip 110 includes an internal cleat 118c formed on extension 118d that fits over the rear of a standard commercial bin and lower step 114 that supports the rear lower edge of the bin. Top rail 112 includes a cleat 112a that runs substantially the width of clip 110. The lower step also includes a cleat 114a with curved upper surface 114b that runs substantially the width of the clip. Beneath top rail 112 is a wall 118 with a lower cleat 118a and an upper surface 118b that is curved to receive a mount, such as a louver on a louvered wall. Extension 118d supports internal cleat 118c. Beneath wall 118 is wall 116 includes lower cleat 116a, an upper surface 116b that is curved to receive a mount, such as a louver on a louvered wall, and an internal support 116c. Beneath wall 116 is lower step 114 including upright wall 114a and a curved upper surface 114b that is curved to receive a mount. In use, the upper rim of an industrial bin fits under internal cleat 118c so that the rear of the bin rests against internal support 116c and the base of the bin rests on lower step 114. External cleats 120a, 118a, 116a carry the weight of the bin and distribute the load across the back wall of the bin so that a higher load may be placed in the bin when hung on as a part of a mounting system.

The side view of a multi-cleat support clip of the present invention on an industrial bin is shown in FIG. 2D. Clip 110 includes an internal cleat 118c formed on extension 118d that fits over the top rear edge 154 of a standard commercial bin 150 and lower step 114 that supports the rear lower edge 158 of bin 150. Top rail 112 includes a cleat 112a that runs substantially the width of clip 110. The lower step also includes a cleat 114a with curved upper surface 114b that runs substantially the width of the clip. Beneath top rail 112 is a wall 118 with a lower cleat 118a and an upper surface 118b that is curved to receive a mount, such as a louver on a louvered wall. Extension 118d supports internal cleat 118c. Cleat 118c retains the top rear edge 154 of bin 150. Beneath wall 118 is wall 116 includes lower cleat 116a, an upper surface 116b that is curved to receive a mount, such as a louver on a louvered wall, and an internal support 116c. Internal support 116c rests against the rear wall 156 of bin 150. Beneath wall 116 is lower step 114 including upright wall 114a and a curved upper surface 114b that is curved to receive a mount. Lower step 114 supports bin base 158 such the weight of bin 150 is supported. In use, the upper rim of an industrial bin 152 is connected to the top rear bin edge 154 that fits under internal cleat 118c so that the rear of the bin rests against internal support 116c and the base of the bin rests on lower step 114. External cleats 120a, 118a, 116a carry the weight of the bin and distribute the load across the back wall 156 so that a higher load may be placed in the bin when hung on as a part of a mounting system.

The side view of a multi-ledge support clip for industrial bins of the present invention is shown in FIG. 2E. Clip 110′ includes an internal cleat 118c formed on extension 118d that fits over the rear of a standard commercial bin and lower step 114 that supports the rear lower edge of the bin. Top rail 112 includes a cleat 112a that runs substantially the width of clip 110′. The lower step also includes upright 114a′ with upper ledge 114b′ that runs substantially the width of the clip. Beneath top rail 112 is a wall 118 with an upper surface 118b that is curved to receive a mount, such as a louver on a louvered wall. Extension 118d supports internal cleat 118c. Beneath wall 118 is wall 116 includes an upper ledge 116b′ that rests on mount, such as a louver on a louvered wall, and an internal support 116c. Beneath wall 116 is lower step 114 including upright wall 114a′ and ledge 114b′ that rests on a mount. In use, the upper rim of an industrial bin fits under internal cleat 118c so that the rear of the bin rests against internal support 116c and the base of the bin rests on lower step 114. External cleats 118a, ledges 116b′ and 114b′ carry the weight of the bin and distribute the load across the back wall of the bin so that a higher load may be placed in the bin when hung on as a part of a mounting system.

The side view of a multi-ledge support clip of the present invention on an industrial bin is shown in FIG. 2F. Clip 110′ includes an internal cleat 118c formed on extension 118d that fits over the rear of a standard commercial bin and lower step 114 that supports the rear lower edge of the bin on a panel 70 with multiple louvers 72. Top rail 112 includes a cleat 112a that runs substantially the width of clip 110′. The lower step also includes upright 114a′ with upper ledge 114b′ that runs substantially the width of the clip. Beneath top rail 112 is a wall 118 with an upper surface 118b that is curved to receive a mount, such as a louver on a louvered wall. Extension 118d supports internal cleat 118c. Beneath wall 118 is wall 116 includes an upper ledge 116b′ that rests on mount, such as a louver on a louvered wall, and an internal support 116c. Beneath wall 116 is lower step 114 including upright wall 114a′ and ledge 114b′ that rests on a mount. In use, the upper rim of an industrial bin fits under internal cleat 118c so that the rear of the bin rests against internal support 116c and the base of the bin rests on lower step 114. External cleats 118a, ledges 116b′ and 114b′ rest on louvers 72 to distribute the load in a bin across the back wall of the bin so that a higher load may be placed in the bin when hung on as a part of a mounting system.

An alternate embodiment of the multi-cleat support clip for industrial bins of the present invention, having three cleats and for use with a standard bin without a top rail cleat is shown in FIG. 2G. Clip 110″ includes an internal cleat 118c formed on extension 118d that fits over the rear of a standard commercial bin and lower step 114 that supports the rear lower edge of the bin. Top surface 118d includes an external cleat 112a and an internal cleat 118c that run substantially the width of clip 110″. The lower step also includes an upright wall 114a with curved upper surface 114b and a stop 114c that run substantially the width of the clip. Beneath top rail surface 118d is a wall 118 with a lower cleat 118a. Beneath wall 118 is wall 116 includes lower cleat 116a, an upper surface 116b′ that that may receive a mount on the exterior of clip 110″ and extends inwardly to contact the back wall of an industrial bin. Beneath wall 116 is lower step 114 including upright wall 114a and a curved upper surface 114b to receive a mount and stop 114c to contact the base of an industrial bin. In use, the upper rim of an industrial bin fits under internal cleat 118c so that the rear of the bin rests against the interior end of upper wall 116b″ and the base of the bin rests on lower step 114. External cleats 120a, 118a, 116a carry the weight of the bin and distribute the load across the back wall of the bin so that a higher load may be placed in the bin when hung on as a part of a mounting system.

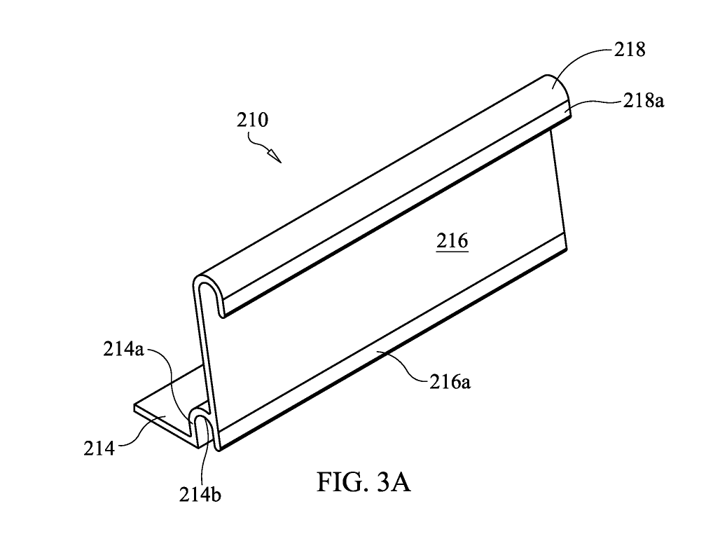

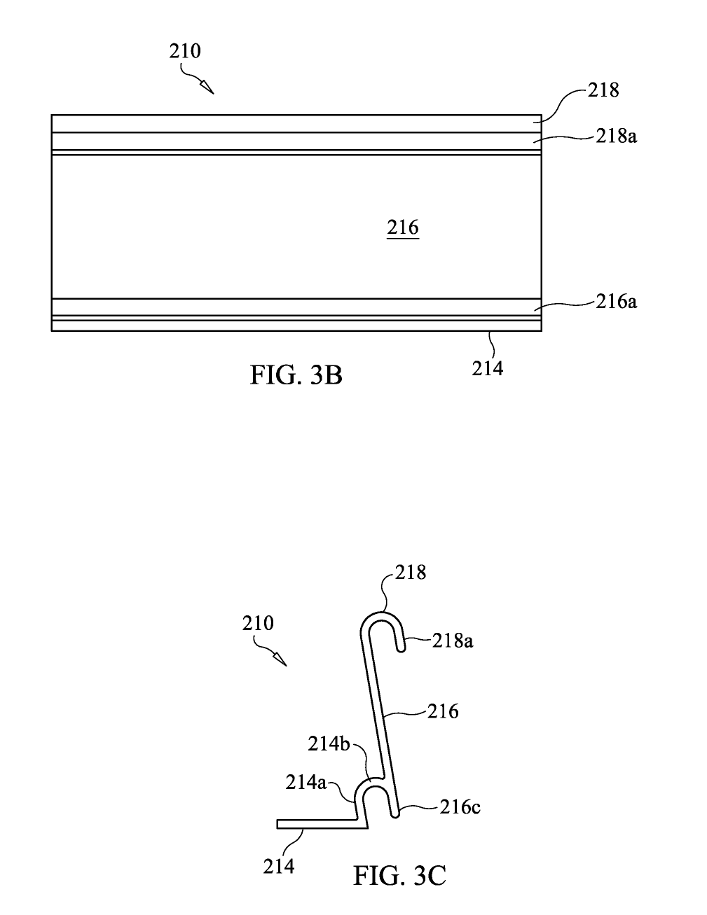

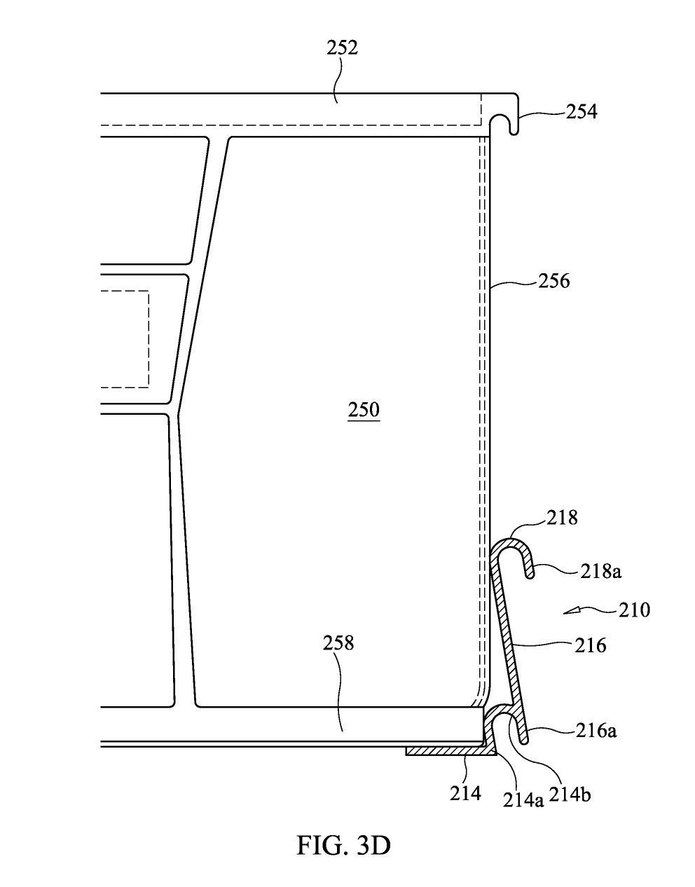

An alternate embodiment of a multi-cleat support clip for industrial bins of the present invention, having two cleats and for use with an industrial bin is shown in FIG. 3A. Clip 210 includes top rail 118 includes a cleat 118a that runs substantially the width of clip 210. The lower step 214 includes cleat 214a with curved upper surface 214b that runs substantially the width of the clip. Beneath top rail 212 is a wall 218 with a lower cleat 116a. In use, the base of a bin rests on lower step 214. External cleats 218a, 216a carry the weight of the bin and distribute the load across the base of the back wall of a bin so that a higher load may be placed in the bin when hung on as a part of a mounting system.

The rear of a multi-cleat support clip for industrial bins of the present invention, is shown in FIG. 3B. Clip 210 includes top rail 218 and cleat 218a that runs substantially the width of clip 210. Beneath top rail 218 is a wall 116 with a lower cleat 116a. Beneath wall 216 is lower step 214.

The side view of a multi-cleat support clip for industrial bins of the present invention is shown in FIG. 3C. Clip 210 includes top rail 118 includes a cleat 118a that runs substantially the width of clip 210. The lower step 214 includes cleat 214a with curved upper surface 214b that runs substantially the width of the clip. Beneath top rail 212 is a wall 218 with a lower cleat 116a. In use, the base of a bin rests on lower step 214. External cleats 218a, 216a carry the weight of the bin and distribute the load across the base of the back wall of a bin so that a higher load may be placed in the bin when hung on as a part of a mounting system.

The side view of a multi-cleat support clip of the present invention on an industrial bin is shown in FIG. 3D. Clip 210 includes top rail 118 includes a cleat 118a that runs substantially the width of clip 210. The lower step 214 includes cleat 214a with curved upper surface 214b that runs substantially the width of the clip. Beneath top rail 212 is a wall 218 with a lower cleat 116a. In use, bin 250 with top rim 252, rear cleat 254, back wall 256 with base 258 supported on lower step 214. External cleats 218a, 216a support the weight of the bin and distribute the load across the base of the back wall of a bin so that a higher load may be placed in the bin when hung on as a part of a mounting system.

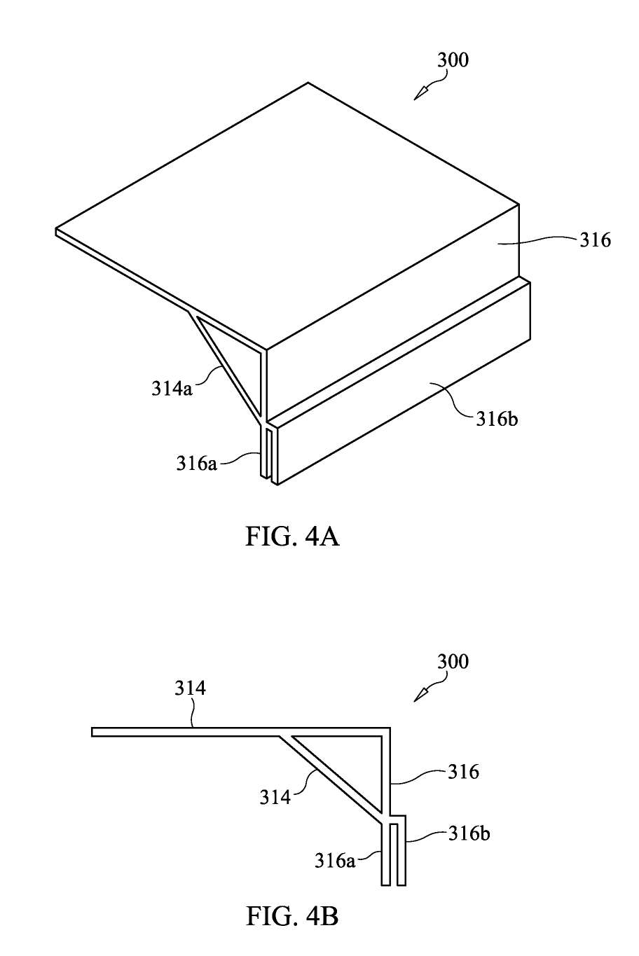

Yet another support is shown in FIGS. 4A and 4B, which illustrates a single-cleat support shelf 300 for industrial bins in accordance with the present invention. The shelf 300 includes a single cleat between walls 316a, 316b formed on rear wall 316 that engages a louver of a louvered panel or a rail in a rail support system. Buttress support 314a may be included between shelf surface 314 and rear wall 316. In use, the support shelf is positioned on a louver or rail support and the shelf supports an industrial bin.

The multi-cleat support clip and multi-ledge support clip of the present invention may be formed by any suitable method including extrusion, stamping, or may be die cast (if metal) or extrusion, thermoforming, injection molding, blow molding, and rotocasting (if formed of polymer). The clip may be formed of any suitable material, such as: metal, polypropylene, polyethylene, polycarbonate, SMMA (styrene methyl methacrylate, acrylic blend), or HIPS high impact polystyrene or other such materials commonly used in the manufacturing of polymeric parts and/or parts made by common forming techniques.

The present invention should not be considered limited to the specific examples described herein, but rather should be understood to cover all aspects of the invention. Various modifications, equivalent processes, as well as numerous structures and devices to which the present invention may be applicable will be readily apparent to those of skill in the art. Those skilled in the art will understand that various changes may be made without departing from the scope of the invention, which is not to be considered limited to what is described in the specification.

What is claimed is:

1. A support clip for industrial bins comprising:
at least one wall having an upper edge and a lower edge and a bin-adjacent side and a bin-opposite side;
a first rail formed at the upper edge of said of the wall having a support formed on the upper edge of the rear wall; and
a lower step at the lower edge of the wall, having a support formed on the bin opposite side and a shelf formed on the bin adjacent side.

2. The support clip of claim 1, wherein the first rail includes a rail configured to fit within a cleat of an industrial bin.

3. The support clip of claim 1, wherein the first rail includes an internal cleat formed on the bin adjacent side configured to fit over the rear wall of an industrial bin.

4. The support clip of claim 1, comprising:
a first wall having the rail formed at the upper edge thereof, and a support formed on the lower edge thereof; and
a second wall joined to the lower edge of the first wall and having the lower step formed on the lower edge of the second wall.

5. The support clip of claim 4, further comprising:
a second rail at the upper edge of the bin-adjacent side of the second wall configured to fit within a cleat of an industrial bin.

6. The support clip of claim 4, further comprising:
an internal support at the upper edge of the bin-adjacent side of the second wall configured to extend to contact the rear wall of an industrial bin.

7. The support clip of claim 1, comprising:
a first wall having the rail formed at the upper edge thereof, and a support formed on the lower edge thereof; and
a second wall joined to the lower edge of the first wall, and a support formed on the lower edge thereof; and
a third wall joined to the lower edge of the second wall and having the lower step formed on the lower edge of the second wall.

8. The support clip of claim 7, further comprising:
a second rail at the upper edge of the bin-adjacent side of the second wall configured to fit within a cleat of an industrial bin.
a third rail at the upper edge of the bin-adjacent side of the third wall configured to fit within a cleat of an industrial bin.

9. The support clip of claim 1, wherein the lower step runs substantially the width of the clip.

10. The support clip of claim 9, further comprising:
a stop formed on the lower step.

11. The support clip of claim 1, wherein the clip is manufactured by a process selected from the group consisting of metal extrusion, metal stamping, or metal die casting or polymer extrusion, thermoforming, injection molding, blow molding, and rotocasting.

12. The support clip of claim 1, wherein the clip is formed of from a metal or a polymer selected from the group consisting of polypropylene, polyethylene, polycarbonate, SMMA (styrene methyl methacrylate, acrylic blend), HIPS (high impact polystyrene) and combinations thereof.

13. A support clip for industrial bins comprising:
a rear wall having an upper edge and a lower edge and a bin-adjacent side and a bin-opposite side;
a cleat formed at the lower edge of the rear wall;
a step formed at the upper edge of the rear wall and extending from the bin-adjacent side of the rear wall.

14. The support clip of claim 13, further comprising:
a buttress extending from the rear wall to the step.

15. A support clip for industrial bins comprising:
a first wall having an upper edge and a lower edge and a bin-adjacent side and a bin-opposite side;
a first rail formed at the upper edge of said of the first wall having a support formed on the upper edge of the rear wall and a cleat formed on the bin opposite side of the upper edge of the first wall;
a second wall having an upper edge and a lower edge and a bin-adjacent side and a bin-opposite side and a support formed on the bin opposite side of the upper edge of the second wall; and
a lower step at the lower edge of the second wall, having a support formed on the bin opposite side and a shelf formed on the bin adjacent side.

16. The support clip of claim 15, wherein the support formed on the bin opposite side of the upper edge of the second wall is a cleat.

17. The support clip of claim 15, wherein the support formed on the bin opposite side of the upper edge of the second wall is a ledge.

18. The support clip of claim 15, comprising:
a third wall between the lower edge of the first wall and the upper edge of the second wall and a support formed on the bin opposite side of the upper edge of the third wall.

19. The support clip of claim 18, wherein the support formed on the bin opposite side of the upper edge of the third wall is a cleat.

20. The support clip of claim 18, wherein the support formed on the bin opposite side of the upper edge of the second wall is a ledge.

21. The support clip of claim 18, further comprising:
a second rail at the upper edge of the bin-adjacent side of the third wall configured to fit within a cleat of an industrial bin.
